(19) United States
(12) Patent Application Publication
(10) Pub. No.: US 2004/0239856 A1
(43) Pub. Date: Dec. 2, 2004

(54) Liquid crystal display device

(75) Inventor: Koichi Miyachi, Soraku-gun (JP)

Correspondence Address: NIXON & VANDERHYE, PC, 1100 N GLEBE ROAD, 8TH FLOOR, ARLINGTON, VA, 22201-4714, US

(73) Assignee: SHARP KABUSHIKI KAISHA, Osaka (JP)

(21) Appl. No.: 10/849,378

(22) Filed: May 20, 2004

(30) Foreign Application Priority Data
May 30, 2003 (JP) 2003-155730

(51) Int. Cl. G02F 1/1337

(52) U.S. Cl. 349/129

(57) ABSTRACT

A liquid crystal display device includes a pair of substrates, i.e. a TFT substrate and an opposed substrate. The pair of substrates sandwich a liquid crystal layer. The TFT substrate has a picture element electrode, and the opposed substrate has an opposed electrode. The picture element electrode has picture element slits. The opposed electrode has opposed ribs within a display region. A height of the opposed ribs is identical to a thickness of the liquid crystal layer. When a voltage is applied to the picture element electrode and to the opposed electrode, a plurality of domains are formed within the display region. The plurality of domains are such that liquid crystal molecules are aligned in different directions from domain to domain. Thus realized is such domain division that (1) enhances alignment regulation of liquid crystal, so that the liquid crystal will not be influenced even if a display panel is pressed, (2) attains an excellent viewing field characteristic, and (3) attains an excellent response.

This nonprovisional application claims priority under 35 U.S.C. §119(a) on patent application Ser. No. 2003/155730 filed in Japan on May 30, 2003, the entire contents of which are hereby incorporated by reference.

### FIELD OF THE INVENTION

The present invention relates in general to a liquid crystal display device, and more specifically to a so-called MVA (Multi-domain Vertical Alignment) liquid crystal display device.

### BACKGROUND OF THE INVENTION

Among conventional liquid crystal devices, VA (Vertical Alignment) liquid crystal display devices using vertical alignment films are excellent in terms of contrast, operating speed, and viewing angle characteristic. Recently, multi-domain technology (so-called MVA system) has been developed in order to attain wider viewing angles. In the multi-domain technology, a display pixel is divided into a plurality of parts, and the liquid crystal of each part is aligned differently.

There are mainly two substrate structures which realize the MVA system.

In the first substrate structure, a protrusion is provided locally under the alignment film. When the voltage is OFF, liquid crystal molecules are aligned vertically with respect to a surface of the alignment film, except in those parts surrounding the protrusion section. In those parts surrounding the protrusion section (hereinafter “tilted alignment section”), the liquid crystal molecules, influenced by the slope of the protrusion, are slightly tilted with respect to the substrate surface.

When the voltage turns ON, the liquid crystal molecules in the tilted alignment section are tilted. Influenced by these liquid crystal molecules, the liquid crystal molecules provided in those parts other than the protrusion section are sequentially aligned in the same directions. As a result, the pixel as a whole is aligned in a stable manner. Thus, the alignment of the display section as a whole is controlled from the protrusion.

In the second substrate structure, an electrode-bored section (a slit) is provided to an ITO pixel electrode, instead of providing a protrusion on the TFT substrate. When a voltage is applied, a distorted electric field (an oblique electric field) is generated in the vicinity of the slit. Therefore, the electric field distribution and the alignment of the liquid crystal can be controlled as in the case where the protrusion is provided. The process increase can be prevented by forming the slit simultaneously with the ITO pixel electrode.

One of such conventional art is disclosed, for example, in JP Patent No. 2947350 (publication date: Sep. 13, 1999, equivalent to U.S. Pat. No. 6,661,488). The liquid crystal display device according to JP Patent No. 2947350 is a liquid crystal display device in which liquid crystal having negative dielectric anisotropy is sandwiched between first and second substrates. The surfaces of the first and second substrates are subjected to a vertical alignment process. The liquid crystal is aligned (i) substantially vertically when no voltage is applied, (ii) substantially horizontally when a predetermined voltage is applied, and (iii) obliquely when a voltage smaller than a predetermined voltage is applied. The liquid crystal display device includes first domain regulating means provided on the first substrate and second domain regulating means provided on the second substrate. The first domain regulating means regulates a direction of alignment in which the liquid crystal is tilted when the voltage smaller than the predetermined voltage is applied. The second domain regulating means regulates the direction of alignment in which the liquid crystal is tilted when the voltage smaller than the predetermined voltage is applied. The first domain regulating means has a protrusion provided at least on an electrode of the first substrate. The protrusion, which is made of dielectric material, protrudes toward a liquid crystal layer. Owing to the protrusion, a part of a contact surface between the first substrate and the liquid crystal is a slant face. When no voltage is applied, the liquid crystal in the vicinity of the slant face is aligned substantially vertically with respect to the slant face. When transition is made from a state in which no voltage is applied to a state in which a voltage is applied, the direction of alignment of the liquid crystal in a surrounding part is determined in accordance with the direction of alignment of the liquid crystal in the vicinity of the slant face.

In this liquid crystal display device, as shown in FIG. 6(a), protrusions 53 are provided on both transparent electrodes 52 sandwiching liquid crystal molecules 51. Because the protrusions 53 cause pretilt 53a of the liquid crystal molecules 51, divisional alignment is realized when a voltage is applied (in an ON-state), as shown in FIG. 6(b).

JP Patent No. 2947350 also discloses the following structures, for example: (1) a structure in which, as shown in FIG. 7, protrusions 63 are provided on both of a transparent electrode 61 and a picture element electrode 62 so that the protrusions 63 also function as spacer columns, (2) a structure in which, as shown in FIG. 8, protrusions 73 are provided on a transparent electrode 71 so that the protrusions 73 also function as spacer columns, and protrusions 74 that do not function as spacer columns are provided on a picture element electrode 72, and (3) a structure in which, as shown in FIG. 9, protrusions 83 are provided on a transparent electrode 81, protrusions 84 are provided on a picture element electrode 82, and the protrusions 83 are respectively connected with a part of the protrusions 84, so that the protrusions 83 and the part of the protrusions 84 also function as spacer columns.

According to these structures, it is not necessary to provide both the spacer columns and the protrusions. As a result, costs are reduced.

In addition, JP Patent No. 2947350 also discloses a structure in which slits are provided instead of the protrusions. In this structure, as shown in FIG. 10, a transparent electrode 91 and a picture element electrode 92, which are provided in an opposing manner, respectively have slits 91a and slits 92a.

Another conventional art is a liquid crystal display device disclosed in Japanese Publication for Unexamined Patent Application, Tokukai 2000-75302 (publication date: Mar. 14, 2000). In this liquid crystal display device, protrusions are provided in those parts that surround the pixels, that is, outside the display regions. The protrusions allow for the regulation of alignment, and are capable of controlling a cell thickness.

A method of filling the liquid crystal is disclosed in Japanese Publication for Unexamined Patent Application, Tokukaihei 6-160871 (publication date: Jun. 7, 1994).

However, the foregoing liquid crystal display devices have the following problems.

First, in the substrate structure shown in FIGS. 6(a) and 6(b), if the display panel is pressed while being used or cleaned, the cell thickness changes, thereby disarranging the alignment. Once the alignment is disarranged, it is difficult to restore the alignment without performing black display. Moreover, the disarranged part is recognized as a rough surface. As a result, display quality is deteriorated.

In the liquid crystal display device in which liquid crystal molecules are aligned vertically at the time of black display, it is preferable to perform optical compensation by using a phase-difference film, so as to suppress light leakage which occurs at oblique viewing angles at the time of black display. In this case, if

(Retardation of liquid crystal)−(retardation of phase-difference film)=0 (1),

is satisfied, no retardation, hence no light leakage, occurs at the oblique viewing angles. Therefore, a viewing field can be expanded under this condition.

However, in the substrate structure of FIGS. 6(a) and 6(b), an apparent cell thickness is thinner in the vicinity of the protrusions 53 by the height of the protrusion 53. As a result, the condition of formula 1 cannot be satisfied. That is, there is a problem that light leakage occurs at the oblique viewing angles in the vicinity of the protrusions 53, thereby narrowing the viewing field.

If the protrusions 63 are provided to both the substrates as shown in FIG. 7, it is necessary that the protrusions 63 of both the substrates have exactly the same height. If the height varies, the apparent cell thickness is thinner in the vicinity of the lower protrusions 63. For the same reason explained above, light leakage occurs at the oblique viewing angles at the time of black display, thereby narrowing the viewing field.

In this case, if the protrusions 63 are made of light-shielding material, and the protrusions 63 closely contact the other substrate, light leakage from gaps is prevented. For this purpose, however, it is necessary that the protrusions 63 of both the substrate have the same height.

In the case where the protrusions 63 are provided to both the substrates, the protrusions 63 become obstacles in filling the liquid crystal. As a result, longer time is required for filling the liquid crystal, and, in some parts, the liquid crystal cannot be filled. Especially in large-size liquid crystal display devices, the liquid crystal is often filled by dropping, as disclosed in Tokukaihei 6-160871. In this case, if the protrusions 63 are provided to the substrate from the side of which the dropping is performed, the protrusions 63 become obstacles, thereby causing the foregoing problems.

Where the liquid crystal molecules contact the protrusions 63, the liquid crystal molecules are aligned substantially vertically with respect to the surfaces of the protrusions 63. Therefore, light leakage occurs there. The light leakage increases luminance at the time of black display, thereby decreasing front contrast. This is problematic because the value of the front contrast is approximately only 250, which is lower than a satisfactory value, i.e. 500, for a liquid crystal television.

Likewise, in the substrate structure shown in FIG. 8, light leakage occurs at oblique viewing angles in the vicinity of the lower protrusions 74 at the time of black display.

There is also light leakage in the vicinity of the protrusions 74. As a result, the value of the front contrast is approximately only 330. However, this value is better than 250, which is the value of the front contrast in the substrate structure shown in FIG. 7. This is because the amount of light leakage is smaller, owing to the structure shown in FIG. 8 in which the protrusions 74 provided to one of the substrates are low.

The substrate structure shown in FIG. 9 is advantageous in that the protrusions 83 provided to one substrate and the protrusions 84 provided to the other substrate can be formed under the same condition. However, this substrate structure has, in addition to the problems of the substrate structure shown in FIG. 8, the problem that it is difficult to align the substrates at the time of bonding, and that even slight misalignment results in an undesirable cell thickness.

In the substrate structure in which the electrodes are provided with slits as shown in FIG. 10, the front contrast is 500 or more, because no protrusion is provided. However, as in the substrate structure shown in FIGS. 6(a) and 6(b) in which the protrusions are formed, the structure of FIG. 10 also has the problem that the alignment is destabilized when the display panel is pressed.

In addition, because no pretilt of the liquid crystal molecules is caused at the time of black display, there is also a problem that the transition from black display to intermediate-color display is very slow.

On the other hand, according to the structure disclosed in Tokukai 2000-75302, in which the protrusions are provided in those parts that surround the pixel, that is, outside the display region, and the protrusions allow for alignment regulation and are capable of controlling the cell thickness, there are the following problems: (1) the alignment is easily disarranged when the display panel is pressed, and (2) it is difficult to restore the alignment once the alignment is disarranged. There are two reasons for these problems. One reason is that the cell thickness at the center of a pixel changes when subjected to pressure, no matter how the cell thickness in those parts that surround the pixel is controlled. The other reason is that the influence of the alignment regulation in those parts that surround the pixel does not easily reach the center of the pixel, because of the distance between the center and those parts that surround the pixel. Therefore, the foregoing problems seriously deteriorate the display quality, especially in large-size LCDs.

In the case of large-size LCDs, the pixel size is nearly as large as 1 mm, but the glass thickness is as thin as 1.1 mm or 0.7 mm. As a result, the center of the pixel is in a flexible state.

### SUMMARY OF THE INVENTION

The present invention was made in view of the foregoing conventional problems. An objective of the present invention is therefore to provide a liquid crystal display device which realizes such domain division that (1) enhances alignment regulation of liquid crystal, so that the liquid crystal will not be influenced even if a display panel is pressed, (2) attains an excellent viewing field characteristic, and (3) attains an excellent response.

In order to solve the foregoing problems, a liquid crystal display device of the present invention includes a pair of substrates respectively having electrodes on opposing surfaces, the pair of substrates sandwiching a liquid crystal layer, a plurality of domains being formed within a display region when a voltage is applied to the electrodes, the plurality of domains being such that liquid crystal molecules are aligned in different directions from domain to domain, at least one of the electrodes on the pair of substrates having an aperture section, the liquid crystal layer having a protrusion section which connects the electrodes.

It may be so arranged that at least one of the electrodes has a protrusion as the protrusion section within the display region, and a height of the protrusion is identical to a thickness of the liquid crystal layer.

According to the present invention, at least one of the electrodes on the pair of substrates which sandwich the liquid crystal layer has an aperture section, and the liquid crystal layer has a protrusion section which connects the electrodes. Moreover, it may be so arranged that at least one of the electrodes has a protrusion as the protrusion section within the display region, and a height of the protrusion is identical to a thickness of the liquid crystal layer.

By thus combining the protrusion section (or a protrusion) and the aperture section, the protrusion section and the aperture section respectively cause pretilt of the liquid crystal molecules. When a voltage is applied (in an ON-state), pretilted parts of the liquid crystal are tilted. Influenced by the pretilted parts of the liquid crystal, the liquid crystal molecules which are not in the vicinity of the protrusion section or in the vicinity of the aperture section are sequentially aligned in the same directions. This liquid crystal alignment control is performed in two different ways, i.e. by the pretilt caused by the protrusion section and by the pretilt caused by the aperture section. Therefore, the picture element as a whole is aligned stably. As a result, such domain division that attains an excellent response is attained, and the transition from black display to intermediate-color display is quick.

If the pretilt of the liquid crystal molecules caused by the protrusion section is used alone so that the picture element as a whole is aligned stably, light leakage occurs in the vicinity of the protrusion section. Therefore, the front contrast is not sufficient.

According to the present invention, the protrusion section (or the protrusion) and the aperture section are combined, and a part of the protrusion section is substituted by the aperture section. This decreases the light leakage which occurs in the vicinity of the protrusion section, thereby improving the front contrast.

If the protrusion is low, light leakage occurs at the time of black display, at the oblique viewing angles in the vicinity of the protrusion.

According to the present invention, the height of the protrusion is identical to the thickness of the liquid crystal layer. Therefore, light leakage does not occur at the time of black display, at the oblique viewing angles in the vicinity of the protrusion.

Moreover, according to the present invention, because the height of the protrusion is identical to the thickness of the liquid crystal layer, the liquid crystal layer sandwiched between the pair of substrates is supported by the protrusion. Therefore, the cell thickness does not change even if the display panel is pressed. Thus, the alignment of the liquid crystal layer is stable.

As a result, it is possible to provide a liquid crystal display device which realizes such domain division that (1) enhances alignment regulation of liquid crystal, so that the liquid crystal will not be influenced even if a display panel is pressed, (2) attains an excellent viewing field characteristic, and (3) attains an excellent response.

For a fuller understanding of the nature and advantages of the invention, reference should be made to the ensuing detailed description taken in conjunction with the accompanying drawings.

### BRIEF DESCRIPTION OF THE DRAWINGS

FIG. 1(a) is a cross-sectional view taken along line A-A in FIG. 2, and illustrates an OFF-state display panel according to one embodiment of the liquid crystal display device of the present invention.

FIG. 1(b) is a cross-sectional view taken along line A-A in FIG. 2, and illustrates an ON-state display panel of the liquid crystal display device.

FIG. 2 is a plan view illustrating a picture element electrode of the liquid crystal display device.

FIG. 3 is a cross-sectional view illustrating a variation example of the liquid crystal display device.

FIG. 4 is a cross-sectional view illustrating another variation example of the liquid crystal display device.

FIG. 5(a) is a cross-sectional view illustrating a display panel in accordance with another embodiment of the present invention, the display panel being such that an opposed rib is subjected to a horizontal alignment process.

FIG. 5(b) is a cross-sectional view illustrating the display panel of the display device shown in FIG. 5(a), the display panel being such that the opposed rib is subjected to a vertical alignment process.

FIG. 6(a) is a cross-sectional view illustrating a display panel of a conventional liquid crystal display device, the display panel being in an OFF-state and provided only with protrusions.

FIG. 6(b) is a cross-sectional view illustrating the display panel of the liquid crystal display device shown in FIG. 6(a), the display panel being in an ON-state and provided only with protrusions.

FIG. 7 is a cross-sectional view illustrating a display panel of another conventional liquid crystal display device.

FIG. 8 is a cross-sectional view illustrating a display panel of yet another conventional liquid crystal display device.

FIG. 9 is a cross-sectional view illustrating a display panel of still another conventional liquid crystal display device.

FIG. 10 is a cross-sectional view illustrating a display panel of yet still another conventional liquid crystal display device, the display panel being provided only with an aperture section.

### DESCRIPTION OF THE EMBODIMENTS

[First Embodiment]

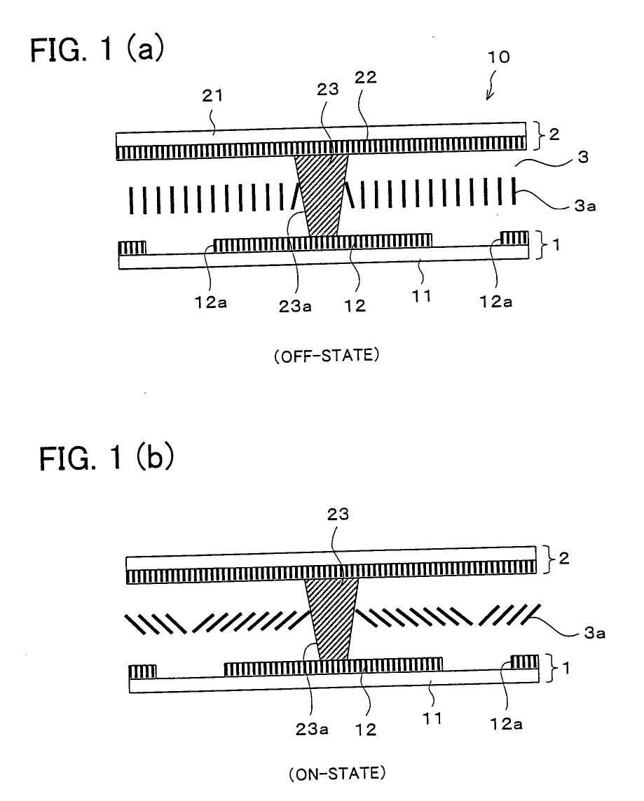

With reference to FIGS. 1(a) to 4, the following describes one embodiment of the present invention, that is, an active matrix liquid crystal display device using thin-film transistors (TFTs). Although taken as an example here is a transmissive liquid crystal display device, the present invention is also applicable to reflective liquid crystal devices and transmissive-reflective liquid crystal display devices. In addition, the present invention is applicable to liquid crystal display devices that perform normally black mode display, and to liquid crystal display devices that perform normally white mode display.

In this specification, a region of the liquid crystal device, the region corresponding to a “picture element”, which is a minimum unit of display, is referred to as a “picture element region”. In a color liquid crystal display device, “picture elements” of R, G, and B constitutes a “pixel”. In an active matrix liquid crystal display device, the picture element region is defined by (i) the pixel electrode and (ii) an opposed electrode opposed thereto. Strictly speaking, in an arrangement provided with black matrix, a picture element section is, among regions to which voltages are applied in accordance with a desired display state, an aperture section of the black matrix.

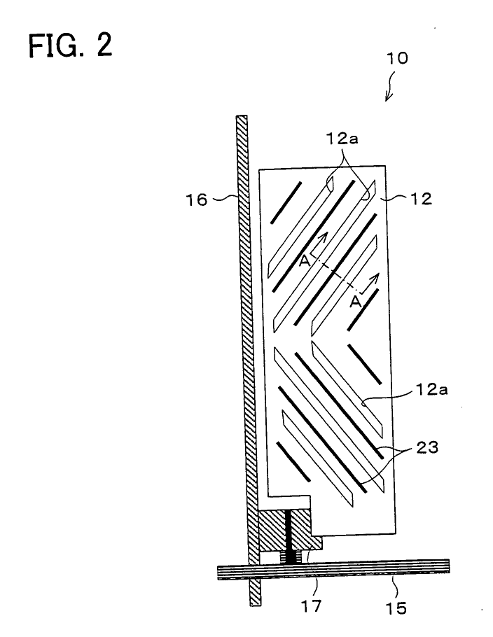

With reference to FIGS. 1(a) and 2, an arrangement of a picture element region in a liquid crystal display device 10 of the present embodiment is described below. For the purpose of simple explanation, a color filter, the black matrix, alignment films, and the like are omitted in these figures.

As shown in FIG. 2, the liquid crystal display device 10 of the present embodiment includes a plurality of gate bus lines 15 and a plurality of source bus lines 16. The plurality of source bus lines 16 intersect with the plurality of gate bus lines 15. At each intersection between the plurality of gate bus lines 15 and the plurality of source bus lines 16, the liquid crystal display device 10 includes a pixel electrode 12 provided in matrix via a switching element 17, which is made up of a TFT. FIG. 2 only shows one picture element region and a gate bus line 15 and a source bus line 16, which are for driving the picture element region.

As shown in FIG. 1(a), the liquid crystal display device 10 includes an active matrix substrate (substrate, hereinafter “TFT substrate”) 1, an opposed substrate (substrate, also referred to as “color filter substrate”) 2, and a liquid crystal layer 3. The liquid crystal layer 3 is provided between the TFT substrate 1 and the opposed substrate 2.

Liquid crystal molecules 3a of the light crystal layer 3 have negative dielectric anisotropy. Because vertical alignment films (vertical alignment layers, not shown) are provided on those surfaces of the TFT substrate 1 and of the opposed film 2 that are on the side of the liquid crystal layer 3, the liquid crystal molecules 3a are aligned vertically with respect to surfaces of the vertical alignment films as shown in FIG. 1(a), when no voltage is applied to the liquid crystal layer 3. That is, initially the liquid crystal layer 3 is aligned vertically. However, depending on types of the vertical alignment films and of a liquid crystal material, the vertically aligned liquid crystal molecules 3a of the liquid crystal layer 3 are slightly tilted with respect to the surfaces of the vertical alignment films, that is, with respect to normal lines of surfaces of the substrates. In general, the term “vertical alignment” is used when liquid crystal molecules are aligned at an axial angle (or axial direction) of approximately 85° or wider with respect to the surfaces of the vertical alignment films.

The TFT substrate 1 of the liquid crystal display device 10 includes a transparent substrate (electrode) 11 (e.g. a glass substrate) and a picture element electrode 12. The picture element electrode 12 is a transparent electrode, and is provided on a surface of the transparent substrate 11. On the other hand, the opposed substrate 2 includes a transparent substrate 21 (e.g. a glass substrate) and an opposed electrode (electrode) 22. The opposed electrode 22 is a transparent electrode, and is provided on a surface of the transparent substrate 21. The alignment in the liquid crystal layer 3 changes with respect to each picture element region, in accordance with voltages applied to the picture element electrode 12 and the opposed electrode 22, which are opposed to one another so as to sandwich the liquid crystal layer 3. The liquid crystal display device 10 performs display by making use of the phenomenon that light transmitted through the liquid crystal layer 3 changes in terms of polymerization state and light amount as the alignment in the liquid crystal layer 3 changes.

On the picture element electrode 12 of the TFT substrate 1, a plurality of picture element slits (an aperture section) 12a are formed. The picture element slits 12a are those parts where a conductive film (e.g. an ITO film) constituting the picture element electrode 12 is not formed. In other words, the picture element slits 12a are those parts from which the conductive film is removed in the shape of slits. Therefore, the picture element slits 12a are apertures whose width (a direction perpendicular to length) is much narrower than the length.

As shown in FIG. 2, the picture element slits 12a are bent in such a manner that sides of the picture element slits 12a extend in directions which respectively form 45° with a long side and a short side of the display panel (a row direction and a column direction of the matrix).

The opposed substrate 2 is provided with opposed ribs (protrusion) 23, which protrude toward the liquid crystal layer 3 and which are parallel to the picture element slits 12a bent by 45°. Therefore, the opposed ribs 23 are also bent by 45°. Although those parts of the picture element slits 12a and of the opposed ribs 23 that are bent by 45° are discontinuous, there is also an option to make them be continuous.

In the present embodiment, on the picture element electrode 12, the picture element slits 12a and the opposed ribs 23 are bent only once. However, the picture element slits 12a and the opposed ribs 23 may be bent twice, three times, or more.

As shown in FIG. 1(a), each opposed rib 23 has tilted side surfaces 23a. Moreover, a surface of the opposed rib 23 has a vertical alignment effect. This is because a vertical alignment film (not shown) is provided on the opposed rib 23. Therefore, by an anchoring effect of the tilted side surfaces 23a, the liquid crystal molecules 3a on the opposed rib 23 is aligned substantially vertically with respect to the tilted side surfaces 23a.

When a voltage is applied to the liquid crystal layer 3 in such a state, an isoelectric line (not shown) is formed. Owing to the isoelectric line, as shown in FIG. 1(b), the liquid crystal molecules 3a in the vicinity of the opposed rib 23 are tilted in conformity with the tilted alignment of the liquid crystal molecules 23a on the slanted side surfaces 23a, the tilted alignment being caused by the anchoring effect of the tilted side surfaces 23a. Moreover, because the liquid crystal molecules 3a in the vicinity of the picture element slits 12a are also aligned along the isoelectric line, the liquid crystal molecules 3a are tilted in the vicinity of the picture element slits 12a.

Thus, in the liquid crystal display device 10, the alignment in the liquid crystal layer 3 is regulated, as shown in FIG. 2, by the picture element slits 12a and the opposed ribs 23, which are bent by 45° in the picture element electrode 12. As a result, when the voltage is applied, the liquid crystal molecules 3a in the liquid crystal layer 3 are aligned in four directions. Every two of the four directions form an angle which is an integral multiple of 90°. In this way, the picture element region of the liquid crystal display device 10 is divided into a plurality of domains having different alignment directions. Therefore, the liquid crystal display device 10 has an excellent viewing field characteristic.

The tilted side surfaces 23a of the opposed rib 23 regulate the alignment, irrespective of the applied voltage. The effect of regulating the alignment, known as the anchoring effect of the alignment films, is very strong. Therefore, even if the alignment is disarranged due to flow of the liquid crystal material caused when an external force is applied to a display panel, the liquid crystal molecules 3a in the vicinity of the tilted side surfaces 23a of the opposed rib 23 are still aligned in the same direction. Therefore, once the flow of the liquid crystal material stops, the alignment of the liquid crystal molecules 3a of the liquid crystal layer 3 as a whole is restored easily. Thus, the liquid crystal display device 10 is resistant to an external force. The liquid crystal display device 10 is therefore suitable for use in PCs and PDAs which are often carried about.

Next, an arrangement example of the liquid crystal display device 10 is described.

For example, in the present embodiment, a thickness (cell thickness) of the liquid crystal layer 3 is 4 μm, and liquid crystal having negative dielectric anisotropy is sealed in the liquid crystal layer 3. The surfaces of the TFT substrate 1 and of the opposed substrate 2, that is, exposed parts of (i) the picture element electrode 12, (ii) the picture element slits 12a, (iii) the opposed electrode 22, and (iv) the opposed ribs 23 are coated with vertical alignment films (not shown).

The width of the picture element slits 12a formed on the picture element electrode 12 is 17 μm, for example. Each picture element electrode 12 has a plurality of picture element slits 12a, for example.

If the opposed ribs 23 are made of highly transparent dielectric material, there is an advantage that the liquid crystal domains, which are formed in accordance with the picture element slits 12a, has a higher contributing rate to the display operation. On the other hand, if the opposed ribs 23 are made of opaque material, there is an advantage that light leakage is prevented from being caused by retardation of the liquid crystal molecules 3a, which are aligned in a tilted state by the tilted side surfaces 23a of the opposed ribs 23. Whether to use a highly transparent material or an opaque material as a material of the opposed ribs 23 may be determined according to, for example, an intended use of the liquid crystal display device. In any case, it is advantageous if the opposed ribs 23 are made of photosensitive resin, in that it is possible to omit the step of patterning the opposed ribs 23 in accordance with the picture element slits 12a.

Each opposed rib 23 has tilted surfaces so that a cross section of the opposed rib 23 becomes smaller towards the picture element electrode 12. Measured on the opposed electrode 22, the width of the opposed ribs 23 is 15 μm, for example.

Domain regulation capacity of the opposed ribs 23 is generated if the height of the opposed ribs 23 is 0.3 μm or higher. However, in order to attain sufficient domain regulation capacity, it is preferable if the height of the opposed ribs 23 is 1 μm or higher. The maximum height is equal to the thickness of the liquid crystal layer 3.

In the present embodiment, as shown in FIGS. 1(a) and 1(b), the opposed ribs 23 are provided to the opposed substrate 2, and the height of the opposed ribs 23 is identical to the thickness of the liquid crystal layer 3.

As a result, the opposed ribs 23, which is opposed to the TFT substrate 1, is in contact with the the TFT substrate 1. Therefore, the cell thickness does not change even if the display panel is pressed. This means that the alignment is very stable. As for a front contrast, although light leakage occurs in the vicinity of the opposed ribs 23, the amount of the light leakage is halved as compared with light leakage that occurs in the liquid crystal display device having the conventional structure shown in FIG. 7. This is because the number of the opposed ribs 23 is halved by providing the picture element slits 12a, instead of providing the opposed ribs 63 alternately to both the electrodes as shown in FIG. 7. As a result, an excellent value of the front contrast, i.e. about 500, is attained.

At oblique viewing angles, a substantive cell thickness of the liquid crystal layer 3 is the same throughout the liquid crystal layer 3. Therefore, the front contrast is excellent in that no light leakage occurs at the time of black display.

In the present embodiment, it is desirable if there are domain boundaries at the opposed ribs 23 and the picture element slits 12a, the domain boundaries being boundaries between domains in which the liquid crystal molecules 3a are aligned in different directions from domain to domain. With this arrangement, the multiple domains ensure a wide viewing field.

When viewed two-dimensionally, the opposed ribs 23 are provided at those parts where the picture element slits 12a are not provided. With this arrangement, the picture element slits 12a and the opposed ribs 23 work in pairs to control the domains. As a result, stable domain-divisional alignment is attained.

The opposed ribs 23 are provided to the opposed electrode 22, which is opposed to the picture element electrode 12 on which the picture element slits 12a are provided. With this arrangement, a taper shape of the opposed electrode 22 causes the pretilt of the liquid crystal layer 3 in a desired direction.

The opposed ribs 23 are made of dielectric material. That is, in order to prevent short circuit, the opposed ribs 23 are preferably made of dielectric material.

The opposed ribs 23 may be made of light-shielding material. If the opposed ribs 23 are made of light-transmitting material, although there is no birefringence because the opposed ribs 23 are usually made of photosensitive resin or the like, light leakage occurs at the oblique viewing angles because there is retardation of optical compensation films. Therefore, in order to prevent the light leakage, the opposed ribs 23 are preferably made of light-shielding material.

In the present embodiment, it is preferable if the liquid crystal molecules 3a of the liquid crystal layer 3 have negative dielectric anisotropy, and the liquid crystal molecules 3a are initially aligned vertically. With this arrangement, it is possible to attain excellent domain-divisional alignment, thereby maximizing effects of the present embodiment.

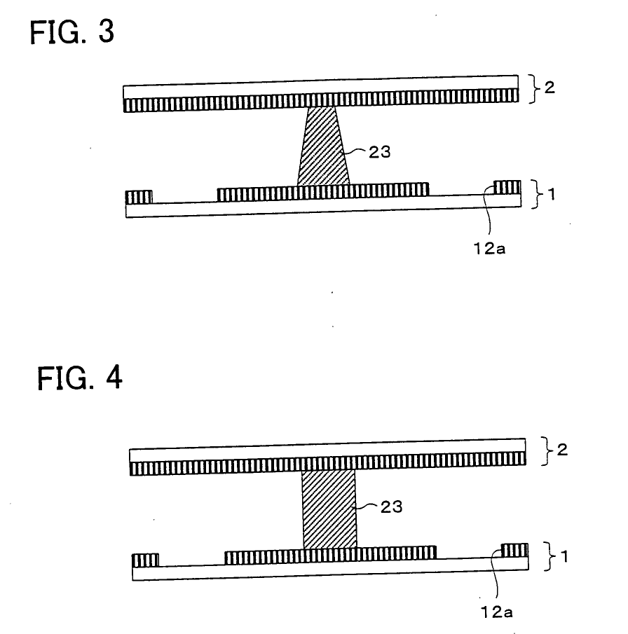

It should be noted that the present invention is not limited to the foregoing embodiment; various modifications may be made within the scope of the present invention. For example, in the present embodiment, each opposed rib 23 has tilted surfaces so that the cross-section of the opposed rib 23 becomes smaller towards the picture element electrode 12; conversely, as shown in FIG. 3, each opposed rib 23 may have tilted surfaces so that the cross-section of the opposed rib 23 becomes larger towards the picture element electrode 12. Moreover, as shown in FIG. 4, each opposed rib 23 may have the same width on the side of the opposed electrode 22 and on the side of the picture element electrode 12.

As described above, the liquid crystal display device 10 of the present embodiment is structured as follows: (1) the picture element electrode 12 (at least one of the picture element electrode 12 and the opposed electrode 22) has the picture element slits 12a, (2) the opposed ribs 23 are provided within the display region, and (3) the height of the opposed ribs 23 is identical to the thickness of the liquid crystal layer 3.

By thus combining the opposed ribs 23 and the picture element slits 12a, the opposed ribs 23 and the picture element slits 12a respectively cause the pretilt of the liquid crystal molecules 3a. When a voltage is applied (in the ON-state), pretilted parts of the liquid crystal are tilted. Influenced by these liquid crystal molecules 3a, the liquid crystal molecules 3a which are not in the vicinity of the opposed ribs 23 or in the vicinity of the picture element slits 12a are sequentially aligned in the same directions. This liquid crystal alignment control is performed by two different ways, i.e. by the pretilt caused by the opposed ribs 23 and by the pretilt caused by the picture element slits 12a. Therefore, the picture element as a whole is aligned stably. As a result, such domain division that attains an excellent response is attained, and the transition from black display to intermediate-color display is quick.

If the pretilt of the liquid crystal molecules 3a caused by the opposed ribs 23 is used alone so that the picture element as a whole is aligned stably, light leakage occurs in the vicinity of the opposed ribs 23. Therefore, the front contrast is not sufficient.

In contrast, in the present embodiment, the opposed ribs 23 and the picture element slots 12a are combined, and a part of the opposed ribs 23 is substituted by the picture element slits 12a. This decreases the light leakage which occurs in the vicinity of the opposed ribs 23, thereby improving the front contrast.

If the opposed ribs 23 are low, light leakage occurs at the time of black display, at the oblique viewing angles in the vicinity of the opposed ribs 23.

In this regard, in the present embodiment, the height of the opposed ribs 23 is identical to the thickness of the liquid crystal layer 3. Therefore, light leakage does not occur at the time of black display, at the oblique viewing angles in the vicinity of the opposed ribs 23.

Moreover, because the height of the opposed ribs 23 is identical to the thickness of the liquid crystal layer 3, the liquid crystal layer sandwiched between the pair of substrates, i.e. the TFT substrate 1 and the opposed substrate 2, is supported by the opposed ribs 23. Therefore, the cell thickness does not change even if the display panel is pressed. Thus, the alignment of the liquid crystal layer 3 is stable.

As a result, it is possible to provide a liquid crystal display device which realizes such domain division that (1) enhances alignment regulation of liquid crystal, so that the liquid crystal will not be influenced even if a display panel is pressed, (2) attains an excellent viewing field characteristic, and (3) attains an excellent response.

On the other hand, if, for example, the protrusions are provided on both the picture element electrode 12 and the opposed electrode 22, it is necessary that the height of the protrusions on the TFT substrate 1 and the height of the protrusions on the opposed substrate 2 be precisely identical. Otherwise, in some regions an apparent thickness is thinner than in the other regions. As a result, light leakage occurs at the time of black display at the oblique viewing angles, thereby narrowing the viewing field.

However, the opposed ribs 23 of the present embodiment are provided only on the opposed electrode 22. Therefore, the height of the opposed ribs 23 rarely varies. As a result, the foregoing problem does not occur.

Moreover, if the protrusions are provided to both the picture element electrode 12 and the opposed electrode 22, there is a problem that it is difficult to align the substrates at the time of bonding, and that even slight misalignment results in an undesirable cell thickness. However, such a problem does not occur in the present embodiment, because the opposed ribs 23 are provided only to the opposed substrate 2.

In the liquid crystal display device 10 of the present embodiment, there are domain boundaries at the opposed ribs 23 and at the picture element slits 12a, the domain boundaries being boundaries between domains in which liquid crystal molecules 3a are aligned in different directions from domain to domain. These multiple domains attain a wide viewing field.

In the liquid crystal display device 10 of the present embodiment, the opposed ribs 23 are provided outside the regions where the picture element slits 12a, when viewed two-dimensionally, are provided. Therefore, the picture element slits 12a and the opposed ribs 23 work in pairs to control the domains. As a result, stable domain-divisional alignment is attained.

In the liquid crystal display device 10 of the present invention, the opposed ribs 23 are formed on the opposed electrode 22, which is opposed to the picture element electrode 12 on which the picture element slits 12a are formed. Therefore, owing to (i) the pretilt of the liquid crystal caused by the opposed ribs 23 and (ii) the pretilt of the liquid crystal caused by the picture element slits 12a, which is opposed to the opposed ribs 23, the liquid crystal is efficiently aligned in the desired direction when a voltage is applied.

In the liquid crystal display device 10 of the present embodiment, the opposed ribs 23 are made of dielectric material.

In order to prevent short circuit, the opposed ribs 23 are preferably made of insulating material. The opposed ribs 23 of the present embodiment satisfies this requirement, because they are made of dielectric material.

In the liquid crystal display device 10 of the present embodiment, the opposed ribs 23 are made of light-shielding material.

If the opposed ribs 23 are made of light-transmitting material, although there is no birefringence because the light-transmitting material is usually photosensitive resin or the like, light leakage occurs at the oblique viewing angles because there is retardation of optical compensation films.

In contrast, because the opposed ribs 23 of the present embodiment are made of light-shielding material, the problem which occurs if the opposed ribs 23 are made of light-transmitting material is solved. As a result, light leakage is prevented.

In the liquid crystal display device 10 of the present embodiment, the liquid crystal has negative dielectric anisotropy, and the liquid crystal molecules 3a are initially aligned vertically with respect to the picture element electrode 12 and the opposed electrode 22. Therefore, it is possible to attain excellent domain-divisional alignment, thereby maximizing the effects of the present embodiment.

In the liquid crystal display device 10 of the present embodiment, the surface of each opposed rib 23 is tilted with respect to the thickness direction of the TFT substrate 1 and of the opposed ribs 23. Therefore, the liquid crystal molecules 3a are aligned in a tilted state in accordance with the tilt of the opposed rib 23. As a result, it is possible to stably control directions in which, when a voltage is applied, the liquid crystal molecules rise or fall.

[Second Embodiment]

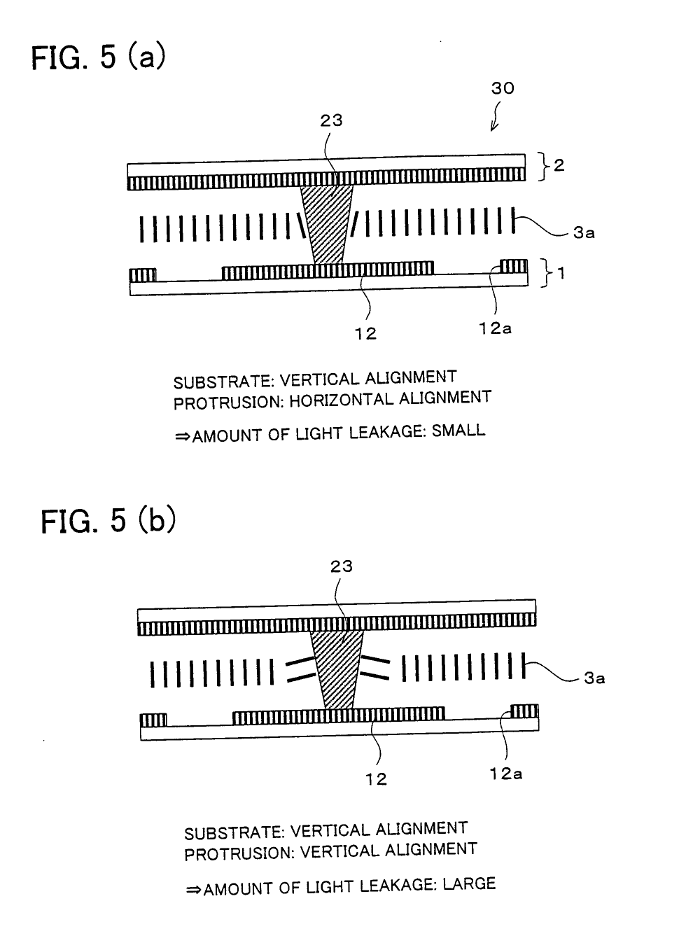

With reference to FIG. 5, the following describes another embodiment of the present invention. The arrangements not mentioned in the present embodiment are identical to those of the first embodiment. For the purpose of explanation, therefore, members whose functions are identical to the members shown in the figures referred to in the first embodiment are labeled with identical referential numerals, and explanations thereof are omitted.

As shown in FIGS. 5(a) and 5(b), a liquid crystal display device 30 of the present embodiment is different from the liquid crystal display device 10 of the first embodiment in that a surface of each opposed rib 23 is subjected to an alignment process which is different from an alignment process of those regions other than the surface of the opposed rib 23.

That is, the surface of each opposed rib 23 is preferably subjected to an alignment process which is different from an alignment process of those regions other than the surface of the opposed rib 23. This arrangement prevents light leakage in the vicinity of the protrusions, thereby increasing the front contrast.

For example, as shown in FIG. 5(a), the surface of the opposed rib 23 is subjected to a horizontal alignment process. Specifically, the opposed rib 23 is made of such material that gives low wettability to the alignment films coating the display region.

In the present embodiment, it is preferable if the surfaces of the TFT substrate 1 and of the opposed substrate 2 are subjected to a vertical alignment process, and the surface of the opposed rib 23 is subjected to the horizontal alignment process.

If the surface of the opposed rib 23 and the other regions are subjected to, for example, the vertical alignment process as shown in FIG. 5(b), significant light leakage occurs at the time of black display.

On the other hand, if the surface of the opposed rib 23 is subjected to the horizontal alignment process as shown in FIG. 5(a), the liquid crystal in the vicinity of the opposed rib 23 is, when the voltage is OFF, aligned in the same direction as the liquid crystal in the other regions. As a result, light leakage does not occur easily. That is, because light leakage is little at the time of black display, the contrast is improved.

This can be realized by patterning optical alignment films, for example. Alternatively, it is also effective to make sure that the alignment film to be applied to the other regions is not applied to the surface of the opposed rib 23.

By adjusting the wettability of the material of the opposed rib 23 as described above, it is possible to align the liquid crystal differently on the surfaces of the substrates and on the surfaces of the protrusions.

Thus, in the liquid crystal display device 30 of the present embodiment, the surface of each opposed rib 23 is subjected to an alignment process which is different from an alignment process of the regions other than the surface of the opposed rib 23. As a result, the light leakage in the vicinity of the protrusion decreases, thereby increasing the front contrast.

Specifically, for example, it is preferable if the surfaces of the pair of substrates, i.e. the TFT substrate 1 and the opposed substrate 2, are subjected to the vertical alignment process, and the surface of the opposed rib 23 is subjected to the horizontal alignment process. The horizontal alignment process may be performed by making the opposed rib 23 by using such material that gives low wettability to the alignment film coating the display region.

With this arrangement, in the OFF-state, the liquid crystal in the vicinity of the protrusion section is aligned in the same direction as the liquid crystal in the other regions. As a result, light leakage does not occur easily. That is, because light leakage is little at the time of black display, the contrast is improved. This can be realized by patterning optical alignment films, for example.

Alternatively, it is also effective to make sure that the alignment film to be applied to the other regions is not applied to the surface of the opposed rib 23. This makes it possible to adjust the wettability of the material of the opposed rib 23, so that the liquid crystal is aligned differently on the surfaces of the pair of substrates, i.e. the TFT substrate 1 and the opposed substrate 2, and on the surface of the opposed rib 23.

It should be noted that the present invention is not limited to the foregoing embodiments, but may be varied in many ways within the scope of the claims. Combinations of different embodiments are also included within the scope of the present invention.

### Example

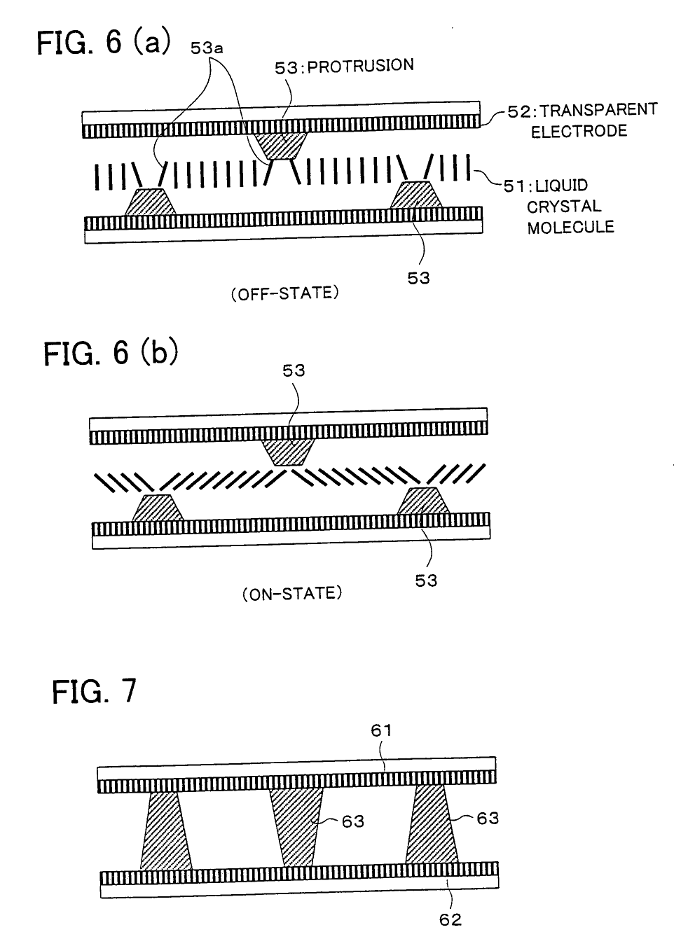

As seen from table 1, the conventional structures 1 to 5 shown in FIGS. 6 to 10 were insufficient in response, alignment, contrast, and/or viewing field. On the other hand, satisfactory results were attained according to the foregoing embodiments.

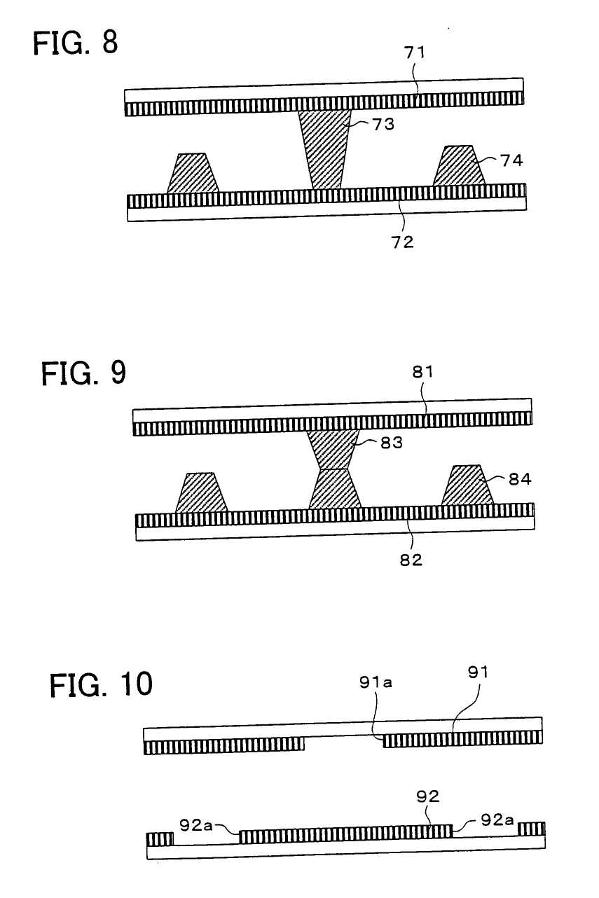

TABLE 1

| | | ALIGNMENT | | |
|---|---|---|---|---|
| | RESPONSE | STABILITY | CONTRAST | VIEWING ANGLE |
| CONVENTIONAL | ∘ | x | 500 | x |
| STRUCTURE | | (ALIGNMENT | | (LIGHT LEAKAGE |
| 1 (FIG. 6) | | DISARRANGED WHEN | | AT OBLIQUE |
| | | PANEL IS PRESSED) | | VIEWING |
| | | | | ANGLES) |
| CONVENTIONAL | ∘ | ∘ | 250 | ∘ |
| STRUCTURE | | | | |
| 2 (FIG. 7) | | | | |
| CONVENTIONAL | ∘ | ∘ | 330 | x |
| STRUCTURE | | | | (LIGHT LEAKAGE |
| 3 (FIG. 8) | | | | AT OBLIQUE |
| | | | | VIEWING |
| | | | | ANGLES) |
| CONVENTIONAL | ∘ | ∘ | 330 | x |
| STRUCTURE | | | | (LIGHT LEAKAGE |
| 4 (FIG. 9) | | | | AT OBLIQUE |
| | | | | VIEWING |
| | | | | ANGLES) |
| CONVENTIONAL | x | x | 500 OR | ∘ |
| STRUCTURE | (ESPECIALLY | (ALIGNMENT | MORE | |
| 5 (FIG. 10) | SLOW IN | DISARRANGED WHEN | | |
| | TRANSITION | PANEL IS PRESSED) | | |
| | FROM BLACK | | | |
| | TO | | | |
| | INTERMEDIATE | | | |
| | COLOR) | | | |
| EXAMPLE | ∘ | ∘ | 500 | ∘ |

Besides the foregoing arrangements, the liquid crystal display device of the present invention may be such that the protrusion is provided to only one of the electrodes on the pair of substrates.

For example, if the protrusions are provided on both the electrodes, it is necessary that the height of the protrusions on both the substrates be precisely identical. Otherwise, in the vicinity of the lower protrusions, the apparent thickness is thinner then in the other regions. As a result, light leakage occurs at the time of black display at the oblique viewing angles, thereby narrowing the viewing field.

On the other hand, the protrusions of the present invention are provided to only one of the electrodes on the pair of substrates. Therefore, the height of the protrusions rarely varies. As a result, the foregoing problem does not occur.

Moreover, if the protrusions are provided to both the electrodes, there is a problem that it is difficult to align the substrates at the time of bonding, and that even slight misalignment results in an undesirable cell thickness. However, such a problem does not occur according to the present invention, because the protrusions are provided to only one of the substrates.

Besides the foregoing arrangements, the liquid crystal display device of the present invention may be such that the protrusions are provided to the electrode which opposes the electrode having the aperture section.

According to this arrangement, the protrusions are provided to the electrode which opposes the electrode having the aperture section. Therefore, owing to (i) the pretilt of the liquid crystal caused by the protrusions and (ii) the pretilt of the liquid crystal caused by the aperture section, which is opposed to the protrusions, the liquid crystal is efficiently aligned in the desired direction when a voltage is applied.

Besides the foregoing arrangements, the liquid crystal display device of the present invention may be such that there are domain boundaries at the protrusion section and at the aperture section, the domain boundaries being boundaries between the domains in which the liquid crystal molecules are aligned in different directions from domain to domain.

According to this arrangement, there are domain boundaries at the protrusion section and at the aperture section, the domain boundaries being boundaries between the domains in which the liquid crystal molecules are aligned in different directions from domain to domain. Therefore, the multiple domains attain a wider viewing field.

Besides the foregoing arrangements, the liquid crystal display device of the present invention may be such that the protrusion section is provided outside a region where, in a two-dimensional view, the aperture section is provided.

According to this arrangement, the liquid crystal display device of the present invention may be such that the protrusion section is provided outside a region where, in a two-dimensional view, the aperture section is provided. Therefore, the aperture section and the protrusion section work in pairs to control the domains. As a result, stable domain-divisional alignment is attained.

Besides the foregoing arrangements, the liquid crystal display device of the present invention may be such that the protrusion section is made of dielectric material.

In order to prevent short circuit, the protrusion section is preferably made of insulating material. The protrusion section of the present invention satisfies this requirement, because it is made of dielectric material.

Besides the foregoing arrangements, the liquid crystal display device of the present invention may be such that the protrusion section is made of light-shielding material.

If the protrusion section is made of light-transmitting material, although there is no birefringence because the light-transmitting material is usually photosensitive resin or the like, light leakage occurs at the oblique viewing angles because there is retardation of optical compensation films.

According to the present invention, because the protrusion section is made of light-shielding material, the problem which occurs if the protrusion section is made of light-transmitting material is solved. As a result, light leakage is prevented.

Besides the foregoing arrangements, the liquid crystal display device of the present invention may be such that the liquid crystal layer has negative dielectric anisotropy, and the liquid crystal molecules are initially aligned vertically with respect to the electrodes.

According to this arrangement, the liquid crystal layer has negative dielectric anisotropy, and the liquid crystal molecules are initially aligned vertically with respect to the electrodes. Therefore, it is possible to attain excellent domain-divisional alignment, thereby maximizing effects of the present embodiment.

Besides the foregoing arrangements, the liquid crystal display device of the present invention may be such that a surface of the protrusion section is subjected to an alignment process which is different from an alignment process of regions other than the surface of the protrusion section.

Besides the foregoing arrangements, the liquid crystal display device of the present invention may be such that a surface of the protrusion section is subjected to a horizontal alignment process so that the liquid crystal molecules are initially aligned in parallel with the surface of the protrusion section.

Besides the foregoing arrangements, the liquid crystal display device of the present invention may be such that an alignment film is provided to the display region of the pair of substrates, whereas no alignment film is provided to a surface of the protrusion section.

According to these arrangements, a surface of the protrusion section is subjected to an alignment process which is different from an alignment process of regions other than the surface of the protrusion section. This prevents light leakage in the vicinity of the protrusions, thereby increasing the front contrast.

Specifically, for example, it is preferable if the surfaces of the substrates are subjected to the vertical alignment process, and the surface of the protrusion section is subjected to the horizontal alignment process. The horizontal alignment process may be performed by making the protrusion section by using such material that gives low wettability to the alignment film coating the display region.

According to this arrangement, in the OFF-state, the liquid crystal in the vicinity of the protrusion section is aligned in the same direction as the liquid crystal in the other regions. As a result, light leakage does not occur easily. That is, because light leakage is little at the time of black display, the contrast is improved. This can be realized by patterning optical alignment films, for example.

Alternatively, it is also effective to make sure that the alignment film to be applied to the other regions is not applied to the surface of the protrusion section. This makes it possible to adjust the wettability of the material of the protrusion, so that the liquid crystal is aligned differently on the surfaces of the substrates and on the surface of the protrusion section.

Besides the foregoing arrangements, the liquid crystal display device of the present invention may be such that the protrusion section is tilted with respect to a thickness direction of the pair of substrates.

According to this arrangement, because the protrusion section is tilted with respect to a thickness direction of the pair of substrates, the liquid crystal molecules are aligned in a tilted state in accordance with the tilt of the protrusion section. As a result, it is possible to stably control directions in which, when a voltage is applied, the liquid crystal molecules rise or fall.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal device, comprising:
a pair of substrates respectively having electrodes on opposing surfaces, the pair of substrates sandwiching a liquid crystal layer,
a plurality of domains being formed within a display region when a voltage is applied to the electrodes, the plurality of domains being such that liquid crystal molecules are aligned in different directions from domain to domain,
at least one of the electrodes on the pair of substrates having an aperture section,
the liquid crystal layer having a protrusion section which connects the electrodes.

2. The liquid crystal display device as set forth in claim 1, wherein:
at least one of the electrodes has a protrusion as the protrusion section within the display region; and
a height of the protrusion is identical to a thickness of the liquid crystal layer.

3. The liquid crystal display device as set forth in claim 2, wherein:
the protrusion is provided to only one of the electrodes on the pair of substrates.

4. The liquid crystal display device as set forth in claim 2, wherein:
the protrusion is provided to the electrode which opposes the electrode having the aperture section.

5. The liquid crystal display device as set forth in claim 1, wherein:
there are domain boundaries at the protrusion section and at the aperture section, the domain boundaries being boundaries between the domains in which the liquid crystal molecules are aligned in different directions from domain to domain.

6. The liquid crystal display device as set forth in claim 1, wherein:
the protrusion section is provided outside a region where, in a two-dimensional view, the aperture section is provided.

7. The liquid crystal display device as set forth in claim 1, wherein:
the protrusion section is made of dielectric material.

8. The liquid crystal display device as set forth in claim 1, wherein:
the protrusion section is made of light-shielding material.

9. The liquid crystal display device as set forth in claim 1, wherein:
the liquid crystal layer has negative dielectric anisotropy; and
the liquid crystal molecules are initially aligned vertically with respect to the electrodes.

10. The liquid crystal display device as set forth in claim 1, wherein:
a surface of the protrusion section is subjected to an alignment process which is different from an alignment process of regions other than the surface of the protrusion section.

11. The liquid crystal display device as set forth in claim 1, wherein:
a surface of the protrusion section is subjected to a horizontal alignment process so that the liquid crystal molecules are initially aligned in parallel with the surface of the protrusion section.

12. The liquid crystal display device as set forth in claim 1, wherein:
an alignment film is provided to the display region of the pair of substrates, whereas no alignment film is provided to a surface of the protrusion section.

13. The liquid crystal display device as set forth in claim 1, wherein:
the protrusion section is tilted with respect to a thickness direction of the pair of substrates.

14. The liquid crystal display device as set forth in claim 1, wherein:
the aperture section is bent in such a manner that sides of the aperture section extend in directions which respectively form 45° with a long side and a short side of the display region of the pair of substrates.

15. The liquid crystal display device as set forth in claim 1, wherein:
the protrusion section is provided in parallel with the aperture section.
